(19) United States
(12) Patent Application Publication
(10) Pub. No.: US 2012/0285338 A1
(43) Pub. Date: Nov. 15, 2012

(54) ATTACHMENT TO BARBEQUE GRILL

(76) Inventor: Brad Anderson, SR., Des Moines, IA (US)

(21) Appl. No.: 13/470,533

(22) Filed: May 14, 2012

Related U.S. Application Data
(60) Provisional application No. 61/485,297, filed on May 12, 2011.

(51) Int. Cl. A47J 37/04

(52) U.S. Cl. 99/441

(57) ABSTRACT

A universal grill attachment for attaching to a spinning mechanism to evenly and thoroughly cook food is provided. The spinning mechanism may be a rotisserie. A drive axle roller is connected to the rotisserie mounted on or near a heating mechanism, such as a grill. A plurality of driven rollers is connected to the drive axle. Chains about sprockets positioned at the ends of the rollers connect the rollers and drive axle. First and second frame members are positioned adjacent ends of the drive axle and plurality of driven rollers. Food, such as hot dogs, bratwursts, sausages, or other cylindrically shaped food, is positioned between the rollers such that the rollers rotate the food over the heat source to thoroughly and evenly cook the food.

### CROSS-REFERENCE TO RELATED APPLICATIONS

This application claims priority under 35 U.S.C. §119 to provisional application Ser. No. 61/485,297 filed May 12, 2011, herein incorporated by reference in its entirety.

### FIELD OF THE INVENTION

The present invention relates generally to the field of barbeque grilling. More particularly, but not exclusively, the invention relates to an improved attachment for grilling or barbequing hot dogs, bratwursts, or the like.

### BACKGROUND OF THE INVENTION

Many people enjoy grilling and barbeques (BBQ). Getting together, cooking, and eating food has long been a tradition of people as a way to socialize, celebrate events, exchange ideas, etc. In addition, people enjoy using grills to cook food such as hamburgers, hot dogs, and bratwursts. When available, people will use BBQ grills, which can use gas, charcoal, smoke, or electric heating elements to cook the food. However, the problem with using any of these types of grills is that the person in charge of cooking must keep a constant watch on the food as it cooks to ensure that the food does not burn, gets fully cooked, and gets cooked evenly. When using a gas or charcoal grill, there is also the possibility of flame-ups, which can char or cause unwanted taste to the food. By constantly watching the food, the chef or grill master may miss out on conversations, events, games, or other activities.

Therefore, devices, attachments, and systems have been designed which allow some food, such as hot dogs, bratwursts, sausages, and other cylindrically shaped foods to cook without the need for constant watching by a grill master. U.S. Pat. No. 7,591,220 discloses a portable roller grill for cooking hot dogs. The '220 patent discloses a roller grill including a plurality of rollers having alternating drive gears and intermediate gears, which cause opposing rollers to roll in opposite directions. The rollers cause the hot dogs to spin on the rollers to cook evenly over a heat source.

However, problems exist with the design of the '220 patent. The gears can become jammed, which causes the rollers to stop spinning The hot dogs will not spin, and will burn on one side and not cook evenly. Additionally, the patent includes attaching a chuck of a rotisserie motor to one side of the roller at a driver gear. Therefore, the chuck may detach from the roller. In other words, the roller may “walk,” separating itself from the adapter rod. Without the connection to the rotisserie motor, the individual rollers will not spin, and thus, the hot dogs will not spin. The idle hot dogs will then burn on one side if not checked on.

Therefore, there is a need in the art for an improved attachment to a barbeque or grill that allows a cook to prepare food such as hot dogs, bratwursts, sausages, and the like, evenly and thoroughly without having to constantly watch the cooking process. There is also a need in the art for a grill attachment that will not jam or stop spinning, and that will not walk from a rotisserie or spinning mechanism.

### SUMMARY OF THE INVENTION

It is therefore a primary object, feature, and/or advantage of the present invention to overcome or improve on deficiencies in the art.

It is another object, feature, and/or advantage of the present invention to provide a grill attachment with spinning rollers that does not rely on gears to control.

It is yet another object, feature, and/or advantage of the present invention to provide a universal grill attachment for cooking food.

It is another object, feature, and/or advantage of the present invention to provide a grill attachment with spinning rollers driven by sprockets and chains to evenly cook hot dogs, bratwursts, sausages, and the like.

It is still another object, feature, and/or advantage of the present invention to provide a grill attachment that will not become detached from a spinning mechanism.

It is still another object, feature, and/or advantage of the present invention to provide a height adjustable grill attachment for attaching to existing rotisserie devices on a grill or other cooking device.

It is yet another object, feature, and/or advantage of the present invention to provide a grill attachment that will not deform under high heat.

These and/or other objects, features, and advantages of the present invention will be apparent to those skilled in the art. The present invention is not to be limited to or by these objects, features and advantages. No single embodiment need provide each and every object, feature, or advantage.

### BRIEF DESCRIPTION OF THE DRAWINGS

FIG. 1 is a perspective view of a grill with a motorized rotisserie and a grill attachment according to the present invention.

FIG. 2 is a top view of the grill attachment of the present invention.

FIG. 3 is a side elevation view of the grill attachment of FIG. 2.

FIG. 4 is an opposite side elevation view of the grill attachment of FIG. 2.

FIG. 5 is a perspective view of the grill attachment of the present invention according to another embodiment.

### DETAILED DESCRIPTION OF THE PREFERRED EMBODIMENTS

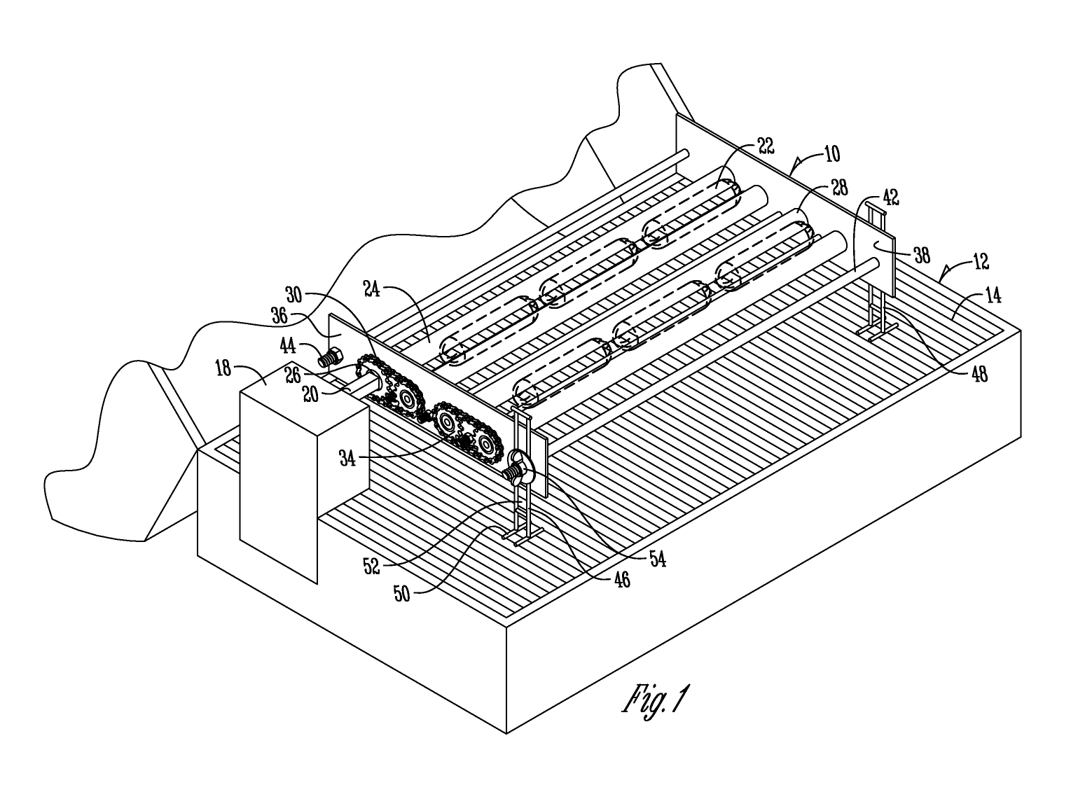

FIG. 1 shows a grill attachment 10 according to the present invention positioned on the rack or surface 14 of a grill 12 and connected to a spinning mechanism 16. The spinning mechanism 16 is a rotisserie device that includes a motor 18 and a removable spit rod or shaft 20. The spit rod or shaft 20 is inserted into the motor 18, which spins the shaft 20. The rotisserie 16 may be powered by electricity, or it may be hand operated such that a user physically spins a crank attached to the spit rod 20 for creating the spinning of the rod 20. In addition, the rotisserie 16 shown in FIG. 1 is affixed to the grill 12 at a specific height. However, it should be appreciated that the rotisserie 16 may be positioned at any height relative to the surface 14 of the grill 12 and that the rotisserie 16 may not even be attached to the grill 12 at all. The rotisserie 16 may be positioned just adjacent a grill 12 or cooking surface. The grill 12 may be any heating element, such as a gas grill, charcoal grill, smoker, electric grill, or the like. Furthermore, the grill attachment 10 of the present invention may be used with an open flame or atop a stove of a kitchen. It is further contemplated that the grill attachment 10 itself be part of a heating element such that the grill attachment 10 heats to cook food 22, such as hot dogs, bratwurst, sausages, or other cylindrically shaped food items directly.

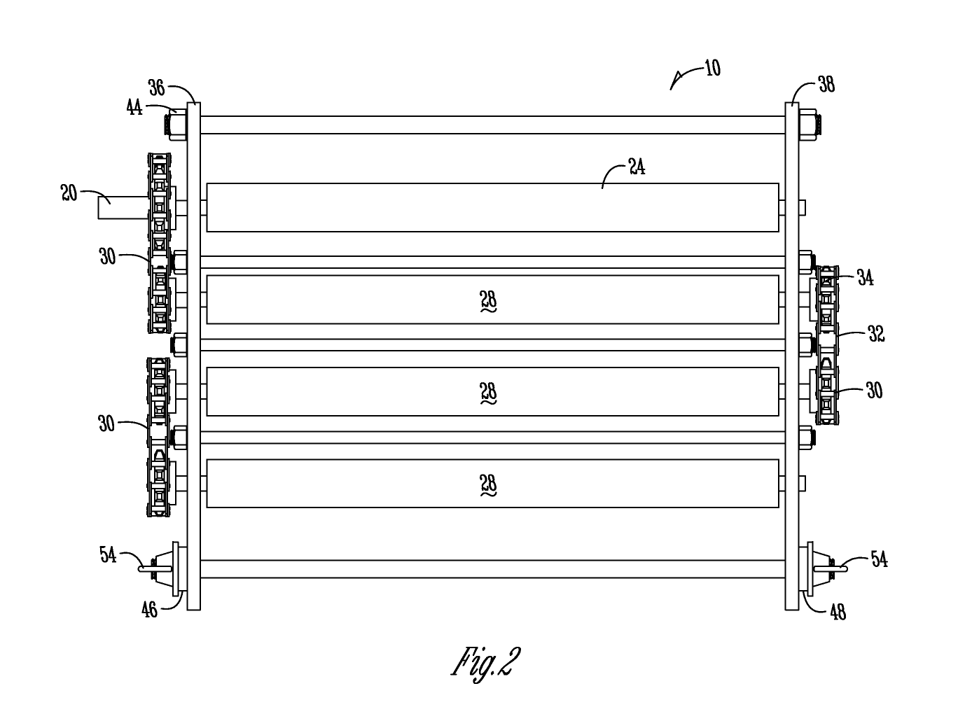

FIGS. 1-4 show an embodiment of the grill attachment 10 according to the present invention. The grill attachment 10 includes a drive axle 24 comprising a cylindrical roller with a square tubing 26 inserted therein. The square tubing 26 is shaped to receive a standard spit rod or shaft 20 of a rotisserie 16. Thus, when the motor 18 of the rotisserie 16 is operated, the rotating rotisserie shaft 20 will rotate the drive axle 24. As shown in the figures, the grill attachment 10 further includes a plurality of rollers 28 positioned between a first frame member 36 and a second frame member 38. The rollers 28 are similar in size and shape to the drive axle 24, but are hollow. The rollers 24, 28 provide a surface for the food 22 to be placed on. Furthermore, the rotation of the rollers will cause the food to spin and to cook evenly.

The rollers 28 are operatively connected to the drive shaft 24 such that the rotation of the drive shaft 24 due to the spinning rotisserie 16 will further cause the rollers 28 to rotate at the same or similar speed. The rotation of the driven rollers 28 is caused by the connection of the rollers to the drive axle 24 via chains 30 positioned on sprockets 34 that are mounted on the ends of the rollers 28 and drive axle 24, 28. The sprockets are attached to the drive axle 24 and rollers 28 at the ends of the drive axle 24 and rollers 28 and are located outside of the first frame member 36 and the second frame member 38. The ends of the drive axle 24 and roller 28 are tapered such that the ends are inserted through apertures 40 through the first and second frame members 36, 38. After the ends of the rollers 28 have been inserted through the apertures 40, the sprockets 34 are attached to the ends thereof. The sprockets 34 may be attached by threading an internal thread of the sprockets 34 to a thread at the ends of the rollers 28, the sprockets 34 may be welded to the rollers 28, or the sprockets 34 may be adhered to the ends of the rollers 28 in other manners. However, it is preferred that the sprockets 34 are connected to the ends of the rollers 28 such that the sprockets 34 and rollers 28 will rotate as one uniform element.

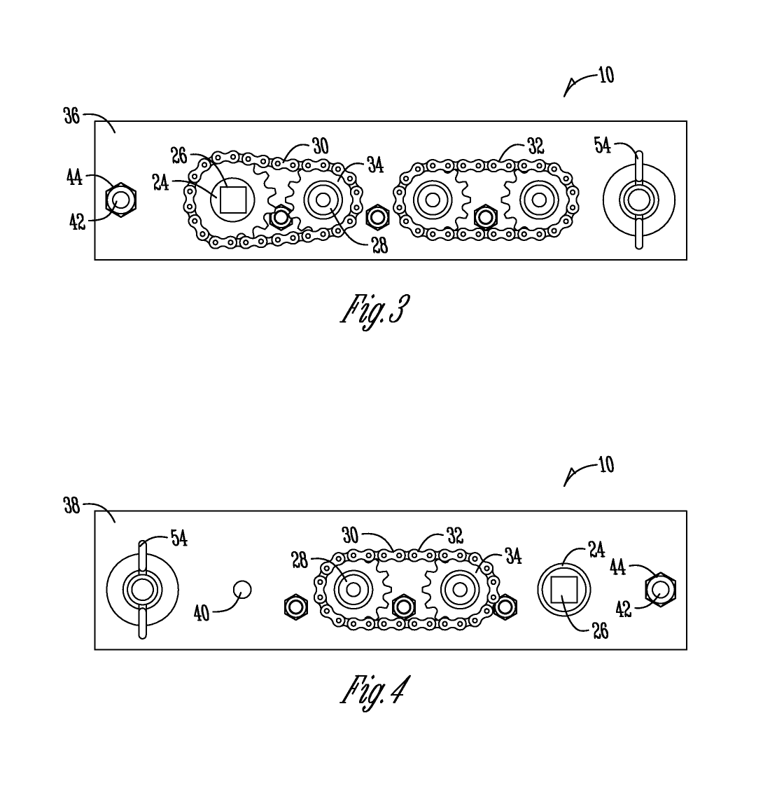

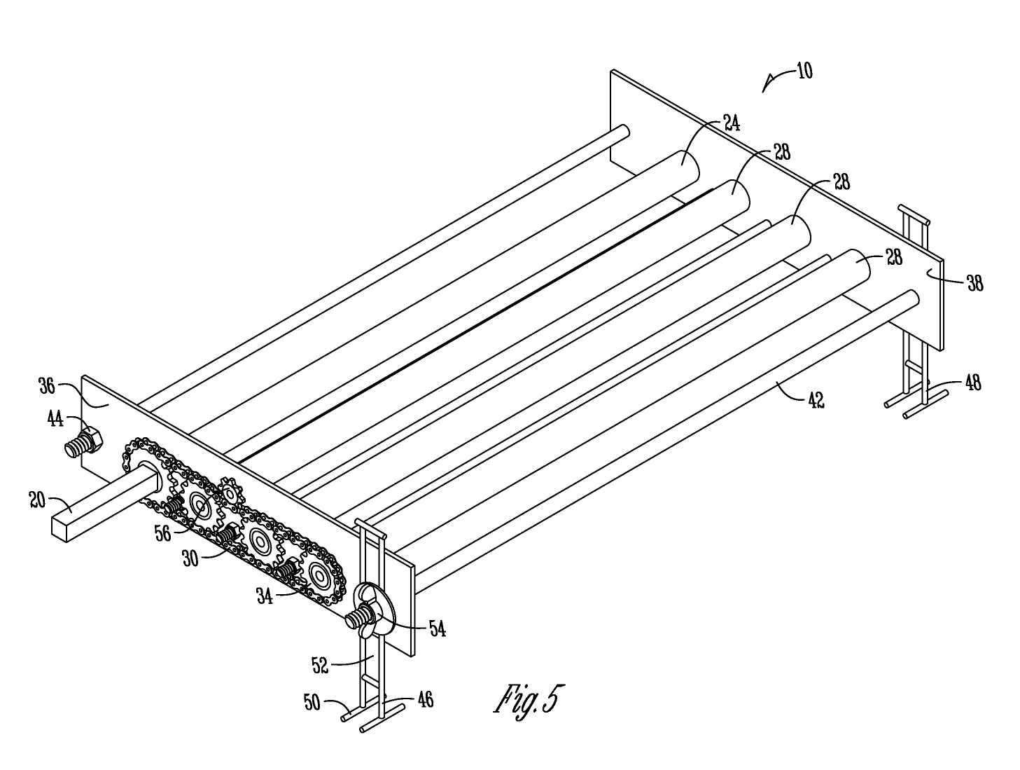

A chain 30 connects two sprockets 34 of the drive axle 24 and/or plurality of rollers 28 such that the two members will rotate at approximately the same rotational velocity. The chains 30 are standard chains including chain links 32 that fit about the ends of the sprockets 34. Therefore, as shown in FIG. 3, a chain 30 will connect the sprocket 34 connected to the drive axle 24 and the sprocket 34 attach to the end of a first driven roller 28 positioned adjacent the drive axle 24. The rotation from the rotisserie 16 will drive the drive axle 24 which will cause the chain to move about the sprocket 34 of the drive axle 24, causing the sprocket 34 of the first driven roller 28 to rotate at the same speed of the chain movement. On the opposite second end of the grill attachment 10 (second frame member 38), the first driven roller 28 connected to the drive axle 24 will include a second sprocket 34 on the outside of the second frame member 38. A chain 30 will connect said sprocket to a sprocket 34 on the next driven roller 28 (second driven roller) such that the rotation of the first driven roller 28 will cause the second driven roller 28 to rotate as well. This is shown in FIG. 4. As shown in FIG. 3, that second driven roller 28 will be connected to the third driven roller 28 via sprocket 34 and chain 30 positioned outside the first frame member 36 such that the second driven roller 28 will cause the third driven roller 28 to rotate as well. Therefore, the drive axle 24 is operably connected to all of the driven rollers 28 such that all of the rollers 28 and the drive axle 24 will rotate at approximately the same rotational velocity.

It should be appreciated that while the present invention includes a drive axle 24 and three driven rollers 28, the invention is not limited to the number of rollers shown, and it is contemplated that the number of rollers will be determined by the amount of food desired to be placed on the grill attachment 10; as well as the size of the heating element. Furthermore, while the drive axle 24 is discussed as being separate from the driven rollers 28, it should be appreciated that the rollers and the drive axle comprise generally the same size, shape and material as one another. The drive axle is merely the directly driven roller of the grill attachment 10. Furthermore, the rollers 28 and drive axle 24 comprise stainless steel. The stainless steel is beneficial because it will heat up and retain heat to aid in the cooking of the food 22. Therefore, once the rollers 28 are warmed, it would be possible to remove the heat source and continue to cook the food. The retention of heat saves on resources and space on a grill or other heating element. As noted above, a shaft, such as a ¼ inch shaft is welded or otherwise attached at the end of the roller 28 to be inserted through the first and second frame members 36, 38. Both ends of the roller are free to rotate within apertures 40 in the first and second frame members 36, 38. In addition, the space between adjacent rollers may be varied via the aperture 40 in the first and second frame members 36, 38 to allow for the cooking of various sizes of foods 22. Put another way, the apertures 40 may be wider than the width of the roller ends such the rollers can be moved along the length of the apertures 40. A retention member (not shown) would hold the roller in place within the apertures 40.

As stated above, the first and second frame members 36, 38 are positioned at the ends of the drive axle 24 and driven rollers 28. The first and second frame members 36, 38 also comprise stainless steel and include apertures 40 therethrough to house the rollers 28 and frame supports 42. The frame supports 42 are generally steel rods that are spaced between the first and second frame members 36, 38 to provide support for the frame members 36, 38. Thus, the frame supports 42 include threads on both ends of the frame supports 42 such that a securing member 44, such as a nut, may be placed on both sides of the frame member 36, 38 to support the grill attachment 10. The use of a securing member 44, such as a nut, allows for the width of the grill attachment 10 to be adjusted. The number of frame supports 42 may be varied, and may also perform a function of catching any food that slips between the rollers of the grill attachment 10. It should be also appreciated that the frame supports 42 may be welded to the first and second frame members 36, 38 to more permanently affix the supports 42 to the frame members 36, 28.

As shown generally in FIGS. 1 and 4, a first and second leg 46, 48 may be affixed to the first and second frame members 36, 38 at a position generally opposite the drive axle 24 of the grill attachment 10. The legs 46, 48 are height adjustable to account for varying heights of the spit rod 20 of the rotisserie 16 . As shown in FIG. 1, the spit rod 20 of the rotisserie 16 is positioned generally a distance above the surface 14 of the grill 12. Therefore, the end of the grill attachment 10 having the drive axle 24 will be raised a distance above the grill surface 12. To ensure that the rollers 28 of the grill attachment 10 have a generally level orientation, the front end of the first and second frame members 36, 38 may be height adjustable to provide the levelness. The terms “front” and “rear” may be used interchangeably, as the drive axle 24 may be at the “front” of the grill attachment 10 depending on the placement of the rotisserie 16 and the setup of the heating element. The term “front” is not to be limited to the orientation shown in FIG. 1.

The first and second legs 46, 48 include a base 50 and an opening 52. The base 50 provides support for the legs 46, 48 such that the legs will not wobble or tip over during use with the grill attachment 10. The opening 52 provides an area to slide the edge of the grill attachment 10 relative to the legs 46, 48 to adjust the height of the grill attachment 10. For example, as shown in FIG. 4, the opening 52 of the leg 50 is positioned about the frame securing member 44, in this case a nut. A washer and leg securing member 54 are then positioned on the outside of the leg 46 with the securing member 54 being tightened to hold the end of the first frame member 36 in place at the desired height. In FIG. 4, the leg securing member 54 is shown to be a wing nut. Therefore, the wing nut may be easily adjusted on the thread of the frame support 42 to hold the washer tightly against the leg 46 such that the grill attachment 10 will not slide within the space 52 of the leg 46. However, to adjust the height of the grill attachment 10, the wing nut is loosened, which allows the nut 44 within the space 52 of the leg 46 to slide along the space as needed. The same process is used to adjust the height of the second frame member 38.

The use of the grill attachment 10 as shown in FIG. 1 is as follows. A spinning mechanism, such as a rotisserie 16, is either attached to a grill or heating element or positioned near such a heating element. The spit rod 20 is detached from the motor 18 of the rotisserie 16 and is inserted through a square tubing 26 of the drive axle 24 of the grill attachment 10. The spit rod 20 is then reinserted into the motor 18 of the rotisserie 16. The opposite end of the grill attachment 10 is then height adjusted by the adjustable legs 46, 48 to level or approximately level the grill attachment 10 relative to the grill surface 14. The height is then secured by the use of wing nuts 54. Food 22 is added to the grill attachment 10 between the drive axle 24 and rollers 28 above the heating element. The rotisserie 16 is then activated. The rotation of the spit rod 20 by the rotisserie 16 will cause the drive axle 24 and accompanying driven rollers 28 to begin to rotate at generally the same rotational velocity. The rotation of the drive axle 24 and driven rollers 28 will cause the food placed between the rollers 28 to rotate as well. As the food is rotated, it is being evenly cooked on all sides by the grill. The rollers 28 and food generally rotate at a low speed. Once the food has reached a desired internal temperature, it is removed from the grill attachment 10 and new food may be added or the rotisserie 16 may be turned off. As the rollers 28 comprise a stainless steel, it should be appreciated that they will require easy clean up as well.

FIG. 5 shows another embodiment of the grill attachment 10 of the present invention. According to FIG. 5, only one chain 30 is used to rotate the drive axle 24 and the accompanying driven rollers 28. Having only one moving chain 30 reduces the number of moving parts of the grill attachment 10. In order to ensure that the chain 30 maintains a good connection with the sprockets 34 at the ends of the rollers 28, a tensioner 56 is added to the first frame member 36. The tensioner 56 may include a bearing that allows it to rotate along with the chain 30. Thus, the one chain 30 is driven by the sprocket 34 of the drive axle 24. The chain 30, which is connected to the ends of the other driven rollers 28, will then cause the additional driven rollers 28 to rotate at approximately the same rotational speed as the drive axle 24. In this embodiment, the ends of the drive axle 24 and rollers 28 at the second frame member 38 may not need the sprockets 34, but still require the ability to rotate. The remainder of the grill attachment 10 will work similarly to the embodiment shown in FIG. 1.

The invention has been shown and described above with reference to the preferred embodiments, and it is understood that many modifications, substitutions, and additions may be made all within the intended spirit and scope of the invention. For example, the number of driven rollers, and therefore, the number of chains and sprockets, may be adjusted to vary the size and cooking capacity of the grill attachment 10. Furthermore, the material used for the components of the invention may vary. For example, it is preferred that food grade materials be used such that they are easy to clean and safe food preparation, however, it is appreciated that other materials, such as Teflon, may be used to coat the rollers and other components of the invention. Furthermore, the invention may also include covers at both the first and second frame members 36, 28 to enclose the chain and rotating sprockets of the rollers such that the grill attachment 10 may be safer. Finally, the legs may include different means of adjusting the height of the grill attachment 10 other than that shown in the Figures. The invention is only to be limited by claims appended hereto.

What is claimed is:

1. A universal grill attachment for attaching to a spinning mechanism to evenly and thoroughly cook food over a heat source, comprising:
a drive axle comprising a roller;
a plurality of driven rollers operably connected to the drive axle, the rollers and drive axle connected by chains; and
first and second frame members positioned adjacent ends of the drive axle and plurality of driven rollers.

2. The grill attachment of claim 1 wherein the drive axle further comprises a square tubing within the roller.

3. The grill attachment of claim 1 further comprising a sprocket attached at the ends of the drive axle and each of the plurality of driven rollers.

4. The grill attachment of claim 1 further comprising first and second legs operably attached to the first and second frame members opposite the drive axle.

5. The grill attachment of claim 4 wherein the first and second legs allow the grill attachment to be height-adjustable.

6. The grill attachment of claim 5 further comprising a securing member operably connected to the legs and frame member to maintain the height of the frame members relative to the legs.

7. The grill attachment of claim 1 further comprising a plurality of frame supports extending between the first and second frame members.

8. The grill attachment of claim 1 wherein one chain connects only two rollers.

9. The grill attachment of claim 1 wherein one chain connects more than two rollers.

10. The grill attachment of claim 1 wherein the drive axle is driven by the spinning mechanism.

11. The grill attachment of claim 1 wherein the first and second frame members include a plurality of apertures for receiving the ends of the drive axle and driven rollers.

12. The grill attachment of claim 11 further comprising a first and second frame cover for covering the chains and ends of the drive axle and driven rollers.

13. The grill attachment of claim 1 wherein the rollers are adjustable to adjust the space between the rollers.

14. A universal grill attachment for attaching to a spinning mechanism to evenly and thoroughly cook food, comprising:
a drive axle operably connected to the spinning mechanism;
a plurality of driven rollers operably connected to the drive axle, each of the plurality of driven rollers having a first end including a sprocket and an opposite second end;
at least one chain operably connecting the drive roller to the plurality of driven rollers;
a first and second frame, said first frame positioned adjacent the first end of the plurality of driven rollers and the said second frame positioned at the second end of the plurality of driven rollers;
a first leg positioned at and extending generally downward from the first frame; and
a second leg positioned at and extending generally downward from the second frame.

15. The universal grill attachment of claim 14 wherein the drive axle comprises a hollow tube with a first end and an opposite second end, said first end including a sprocket.

16. The universal grill attachment of claim 15 further comprising a guard member configured to cover the first end of the drive axle and the first ends of the plurality of driven rollers including the sprockets.

17. The universal grill attachment of claim 15 wherein the first and second legs are height adjustable.

18. The universal grill attachment of claim 15 further comprising at least one bearing member configured to aid in the movement of the at least one chain.

19. The universal grill attachment of claim 15 further comprising at least one chain tensioner extending from the first frame and operably connected to the at least one chain.

20. The universal grill attachment of claim 15 further comprising a plurality of frame rods extending from the first frame to the second frame.
